(19) United States
(12) Patent Application Publication
(10) Pub. No.: US 2004/0138316 A1
(43) Pub. Date: Jul. 15, 2004

(54) Parasiticidal composition and parasiticidal treatment method using the composition

(76) Inventors: Piero Perucci, Perugia (IT); Mario Principato, Perugia (IT)

Correspondence Address: JACOBSON HOLMAN PLLC, 400 SEVENTH STREET N.W., SUITE 600, WASHINGTON, DC, 20004, US

(21) Appl. No.: 10/474,519

(22) PCT Filed: Apr. 22, 2002
(86) PCT No.: PCT/EP02/04418

(30) Foreign Application Priority Data
Apr. 23, 2001 (IT) MI01A000851

(51) Int. Cl. A01N 27/00

(52) U.S. Cl. 514/762

(57) ABSTRACT

The present invention relates to a parasiticidal composition acting by inhalation or contact and containing Hexane as the active substance. The present invention also relates to a parasiticidal treatment method using the composition containing Hexane.

Parasiticidal treatments are conducted essentially by the use of substances designed to exert an action on the parasite by contact, ingestion or inhalation.

Paraciticidal action by contact and ingestion requires that the substance be carried into direct contact with the parasite for more or less long periods of time and involving the necessity that the parasiticide be deposited even on the substrate where the parasite is present and on which it lives and reproduces.

Substances with parasiticidal action do not generally have nontoxic characteristics for man and their presence is contraindicated on all products which will come into contact with man and to the highest degree on foodstuffs or materials designed to come into direct contact with foodstuffs.

In these cases the parasiticidal struggle is conducted preferably with chemical substances carrying out a parasiticidal action by inhalation with satisfactory effects in an acceptable degree especially if the toxic effect is selective and specific for the parasite it is wished to combat.

However, it often occurs that there can be a phenomenon of surface absorption of the parasiticide by the product and in particular when the effectiveness of the treatment requires operation in a saturated environment.

In the struggle to eliminate or at least limit the presence of parasites in food products, in addition to the use of chemical compounds it was attempted to use physical means like infrared and ultraviolet rays, microwaves, high temperature and high pressure steam. But these treatments did not prove sufficiently effective for finding a practical and satisfactory application.

The research which led to the present invention was based on the prior art which proposed the use of fumigants and toxic gasses in the parasiticidal treatment of foodstuffs has been documented by the world scientific literature for a long time.

The prior art proposed for example the use of carbon sulfide (CS₂) which displays high insecticidal effectiveness but high toxicity for man and dangerous use due to its inflammability and explosive nature in the presence of air. Carbon tetrachloride (CCl₄) is not inflammable and is less toxic than carbon sulfide but exerts slight parasiticidal power. Methyl bromide (CH₃Br) is very poisonous for man. Ethylene oxide (C₂H₄O) is inflammable, explosive and highly toxic for man. Ethylene bromide (C₂H₄Br) has toxic, irritant and blistering properties.

The research which led to the present invention was directed towards identification of a substance capable of acting effectively on arthropods by contact or inhalation with low toxicity for man and which would not cause any noticeable biological effect especially if used on foodstuffs.

Parasiticidal effectiveness by contact would have been a preferred characteristic by reason of the capability of treatment with the parasiticide even of environments designed for foodstuffs processing considering the acceptability of contact with foodstuffs with vapors of the substance and thus a not high criticality of the reclamation of the environment after treatment.

Surprisingly the present invention recognized effective paraciticidal action exerted by n-Hexane which is exerted selectively against various species of arthropods both by inhalation and contact.

The purpose of the present invention is accordingly the use of a parasiticidal composition containing n-Hexane as the active principle and the technique of application in parasiticidal treatment of a product, biological or not, contaminated even by infesting and/or pathogen arthropods. The paraciticidal action of n-Hexane to arthropods can be exerted either in the liquid state or the aeriform state.

The present invention will be better understood and the results achieved with it appreciated from the following description of examples of practical application.

Use for Inhalation

One of the major hygienic and sanitary problems of the foodstuffs industry and in particular in rooms for preservation or ripening is that of massive and permanent infestation both of the environment and the foodstuffs by arthropods which feed on the microscopic plants developing on the foodstuffs in preservation and of the product itself.

The difficulty of containing the development of such parasites unavoidably involves the marketing of contaminated foodstuffs and consequently the real risk of spreading of the infestation to other foodstuffs such as floury substances, cheese and ripened sausages in addition to causing a serious loss in production (estimated to be more than 20%). This is due to the biological plasticity of the arthropods which can adapt readily to different substrates and thus become a potential contaminant not only of various foodstuffs but especially of the environment in which they were fortuitously introduced and where they can persist, active or quiescent, for months and sometimes years. These arthropods in addition can cause allergy problems for man either when inhaled of swallowed or when they come repeatedly in contact with the skin.

From the scientific bibliography, in the mite prevention treatment of ham it emerges for example that the use of different chemical substances either of natural origin or synthetic has not at present given any positive outcome for solving this problem neither in terms of control nor in terms of limiting the development of these parasites. Specific experimentation was performed on mites because of their widespread presence and danger of the infestation involving foodstuffs and in view of the unsatisfactory results with parasiticidal compositions of the prior art. Under these conditions the experimentation appears particularly significant for throwing light on the results of the present invention.

Laboratory tests were carried out preliminarily both in a ventilated environment and a confined environment by means of treatments by contact or inhalation with 100% commercial n-Hexane, for the sake of brevity called hereinafter “Hexane” with reference to the performance of the practical experimental tests whose execution procedures follow.

The preliminary tests on the parasiticidal effectiveness by inhalation conducted in a very small environment (Petri capsule) showed strong toxic activity of the Hexane on arthropods verifiable after only a few minutes treatment. The tests were repeated by performing treatments of different duration from 15 minutes to two hours and always gave positive results confirming the high effectiveness of the substance in causing the death 15 minutes after treatment of all the mites present. The arthropods were then returned to optimal conditions (18° C.-20° C., 80% RH) to verify that none of them returned to life within 15 days. Treatment tests with Hexane for longer periods of time showed toxic effects even on eggs with strong hatching reduction.

Subsequent tests were conducted in a closed chamber consisting of a box (70 cm×50 cm by 120 cm high) with polypropylene walls as this material is among those not attacked by Hexane such as other synthetic plastic materials among which polyethylene, polyester, polyethylene terephthalates in addition to aluminum, copper, carbon steel and stainless steel. The box had a first opening controlled by a tap for creating vacuum and a second opening controlled by a Teflon tap for inlet of the Hexane. On the bottom of this box was located a circular aluminum tank (dia. 22 cm×height 15 cm) on the bottom of which was arranged a copper coil in which was circulated hot liquid to heat to evaporation the Hexane fed into the tank. The material to be tested was placed in the box which was then closed hermetically.

Tests were performed with two different techniques, to wit, at reduced pressure and at atmospheric pressure.

Both by the reduced pressure technique and the atmospheric pressure technique quantities of Hexane variable from 50 ml to 800 ml were fed through a second tap having in it a silicon tube drawing from the bottom of the aluminum tank. By circulating hot liquid in the heating coil the Hexane present in liquid phase in the tank was held at a temperature of 70° C. to 75° C. for the entire period of experimentation in order to achieve complete evaporation of the Hexane. A blower was placed on the bottom of the box for homogeneous distribution of the Hexane vapors in the treatment environment. This homogenization circulation of the distribution was adopted to simulate the circulation which becomes necessary when operating on an industrial scale in rather large environments with a consequent need to avoid stratification of the Hexane in the lower parts of the treatment environment since upward transport of the Hexane is made difficult in particular by the low temperatures.

The temperature in the box during all the tests and as a function of the material to be treated (biological or not), was included in the range 5° C. to 75° C. The duration of the treatment was between 1 and 72 hours for both procedures (atmospheric pressure or reduced pressure). In the reduced-pressure tests the pressure was held in a range of 0.5N/cm₂ to 5N/cm₂.

At the end of treatment time the box was reopened and the Hexane vapors allowed to free themselves outward.

Average consumption in the various tests was 480 ml of Hexane equivalent to approximately 720g per m₃ of air which can be considered approximately the average concentration of Hexane kept in the environment for the maximum period of treatment of 72 hours at surrounding temperature and atmospheric pressure. With this experimentation the results found confirmed the results obtained in Petri capsule.

Arthropods were introduced both on nonbiological supports such as glass, printed paper, differently colored fabrics (cotton, silk, linen, skin, wool and synthetic) and on biological materials such as ham, hard wheat pasta and hard crust cheeses. The result was that none of the materials mentioned underwent structural and/or organoleptic harm. Also treated was biological material infested by mites, larvae and adult forms of cheese fly and Galleria mellonella using the entire set of tests described above. Already after 2 hours, exposure to the Hexane vapors proved to have the desired effect on nearly all parasites infesting the ham and dressed pork products such as mites, larvae and adult forms of cheese fly with complete reclamation of the product after 48 hours of treatment. The same result was achieved on mites and insects infesting cheese products, mattresses, cushions, sheets, carpet, drapes, etc.

In accordance with the purposes of the present invention it was found that no accumulation of toxic substances is found nor are there found particular tastes and odors caused by the treatment.

From the experimentation conducted it was observed that the treatment environment temperature has a considerable influence on the effectiveness of the paraciticidal action of the Hexane. For example, it was noted that thermostat control of the environment around the ranges 15° C. to 45° C. for biological material and 25° C. to 75° C. for non biological material kept uniformly distributed with suitable ventilation of the environment gave satisfactory results with reduction of treatment times and concentration of Hexane vapors and consequently consumption of substance.

On the basis of the experiments performed it was concluded that the parasiticidal treatment was already considerably effective when a concentration of 250 g per cubic meter of air is reached. Higher percentages can reduce the duration of the treatment for a complete disinfestation and accelerate the spreading of the active principle in the product to be treated to achieve deeper levels where it is required by the nature of the product and the type of infestation to which it is subject.

The above mentioned tests were conducted by dispersion of the n-Hexane in vapor form obtained by heating of the composition in liquid phase to obtain its passage to the vapor phase. However, any other technique could be used for dispersion of the composition, for example fine nebulization where the sizes of the drops are sufficiently small to cause evaporation of the composition without abatement of the liquid phase. Nebulization or micronizing could be achieved by projection of the liquid at any adequate pressure by nebulizing nozzles.

Use by Contact

The tests conducted in a ventilated environment by directly treating organic material from contaminated ham displayed intensification of the typical aromas of this food and proved the usability of Hexane in accordance with the present invention in the disinfestation of foodstuffs.

The tests conducted in a ventilated environment showed a weak, temporary toxic effect on mites. On the other hand there was found significant toxic effect of the Hexane by contact with the insects.

On the basis of the experimental results there was found a high abatement power on flies, mosquitoes, cockroaches, corrodentia, thysanura (Diptera Brachycera and Nematocera, Psocoptera, Blattodea) et cetera.

As known, n-Hexane displays a low toxicity index for man following contact while it displays a high acute toxicity index by inhalation. It accordingly lends itself to not significantly dangerous handling in adequately ventilated environments. Its high volatility with practically no possibility of decomposition under normal conditions allows it to be readily and totally removed from surfaces coming into contact with it.

The performance of parasiticidal treatment in a confined environment which is ventilated after treatment with possible recovery and condensation of the vapors makes the relatively greater inhalation toxicity not disadvantageous for man by reason of the prompt elimination of n-Hexane from the products treated by merely adequately ventilating them.

The parasiticidal substance in accordance with the present invention is accordingly useful in numerous applications among which may be recalled the following merely by way of non-limiting example:

reclamation of ham and pork products in general from infesting mites and cheese flies;

reclamation of cheese products from infesting insects and mites;

reclamation of flour, cereals, dried fruit et cetera from infecting insects and mites; the composition in accordance with the present invention kills all insects and mites infesting preserved flour products (pasta, flour et cetera) by stopping development of the infestation and it also acts on the larvae of coleopters, weevils and beetles et cetera as well as their adult forms;

reclamation of furniture worm-eaten by larvae and adults of Anobiidae and in particular combating infestations of Pyemotes ventricosus, a mite infesting worm-eaten furniture which must be considered the primary cause of human dermatitis of environmental origin;

sterilization of clothing, linen, sheets in case of scabies, lice or cheyletids; the composition of the present invention can be used effectively to kill all mobile forms of Sarcoptes scabiei and the neanidi of Pediculus humanus capitis, P.h. carporis and P. pubis which cause relapse of infestations of scabies and Pediculosis infection; exposition of the product to clothing, linen, sheets and used articles ensures neutralization of all stages of attack of the parasites;

reclamation of mattresses, cushions and plush infested with mites; the composition acts effectively on mites of the genus Dermatoophacoides present in beds and capable of causing bronchial asthma in man; the product if used three times spaced between 7 days and 15 days completely stops the development of mites and avoids the formation of allergens; it acts simultaneously on free mites such as Glycyphagus domesticus, the cause of itching and dermatitis, as well as bed bugs and lice if present;

reclamation of environments from pathogenous insects and mites, elimination of pathogenous insects and mites present in dwellings and difficult to locate such as domestic and wild bedbugs, Argasidi, Ixcodidi carriers of illnesses like I. ricinus, the agent of Lyme's disease, phlebotomous agents of leishmaniosis et cetera;

reclamation of libraries infesting insects and mites; with this product it is possible to treat where present very delicate articles such as old books, maps, prints et cetera even if difficult to reach; the product acts on thysanura, book lice and on anobiidae which ruin paper products, and termites;

reclamation of museums and scientific collections, in particular where there are stuffed animals, collections of insects, herbals infested with Anthrenus, Attagenus, Lepisma et cetera;

reclamation of valuable or electronic articles infested by insects or mites as the composition in accordance with the present invention does not attack numerous types of plastic and other materials;

reclamation of dogs' beds, cushions for dogs or cats infested with pathogenous fleas or mites;

reclamation of aviculture farms; the composition acts by contact even on larvae of coleoptera tenebrionidi and can be used effectively to destroy the larvae of Alphitobius diaperinus at the time of migration from the excrement pit to the isolation structures of the avicular farm;

downing of insects such as flies and mosquitoes by contact; and

sterilization of dung heaps through combined action either by contact of inhalation.

The above listed information is to be understood as purely explanatory and useful to better clarify the possible effects and application procedures of the composition in accordance with the present invention without in any way being understood as limiting.

Applicable in the use of the composition in accordance with the present invention are all techniques useable for the distribution of parasiticidal liquids designed to act by contact or the techniques usable by vaporization of substances in confined environments for treatment by inhalation.

When acting by inhalation, the articles to be disinfected can be placed in a closed chamber of adequate size where the composition is vaporized in the quantity necessary for paraciticidal action in a reasonable treatment time.

In case of treatment of material not readily transportable the enclosed space may be created around the article with vapor-proof fabrics to create the confined environment in which to vaporize or introduce the composition of the present invention in the form of vapor. Disinfestation of rooms with their contents can be performed by direct vaporization of the composition within it. In all cases, it might be advantageous to provide for recovery of the vapor and easy condensation thereof for final recovery of the Hexane with benefit for consumption of the product and limiting its dispersion in the air.

Vaporization of the Hexane in the liquid state can be performed with any apparatus or device suitable for the purpose for fine nebulization or passage of state following application of heat or with combination of the phenomena. Choice of the most adequate vaporization technology will be done by the technician on the basis of the size and type of the treatment environment with the necessary precautions in view of the inflammability characteristics.

A particular advantage of the present invention lies in the above mentioned facility with which the composition can be removed in a short time from environments or articles by mere ventilation without phenomena of permanence and presence of alteration residue, odors or coloration of the products treated, which are often limiting phenomena in the use of known parasiticides.

The composition in accordance with the present invention can contain in addition to Hexane any additive or modifier which might have a synergic effect or merely exert an advantageous effect in the application or use of the active principle and to this end improve its physical and chemical characteristics and safe handling.

1. Parasiticidal composition acting by inhalation or contact characterized in that it contains Hexane as the active principle.

2. Parasiticidal composition in accordance with claim 1 characterized in that it consists essentially of Hexane.

3. Parasiticidal composition in accordance with claim 1 characterized in that the Hexane is in the form n-Hexane.

4. Parasiticidal composition in accordance with claim 1 characterized in that it is in the liquid phase.

5. Parasiticidal composition in accordance with claim 1 characterized in that it is in liquid phase distributed on surfaces.

6. Parasiticidal composition in accordance with claim 1 characterized in that it is in the liquid phase distributed by boiling in vapor phase in a confined environment.

7. Parasiticidal composition in accordance with claim 1 characterized in that it is in the vapor phase dispersed in the air in a confined environment.

8. Parasiticidal treatment method characterized in that it comprises the use of the composition in accordance with claim 1.

9. Parasiticidal treatment method characterized in that it comprises distribution of the composition in accordance with claim 1 on parasite infested surfaces.

10. Method in accordance with claim 8 characterized in that it comprises dispersion of the composition in accordance with claim 1 in vapor phase in the air in a confined environment in which are gathered parasite infested products.

11. Method in accordance with claim 10 characterized in that pressure between atmospheric pressure and 1 N/cm₂ is maintained in the confined environment.

12. Method in accordance with claim 10 characterized in that the quantity of composition dispersed in vapor phase corresponds to a concentration of composition between 100 g and 1100 g per cubic meter of air and preferably around 500 g per cubic meter of air.

13. Method in accordance with claim 10 characterized in that the composition is dispersed in the environment in vapor form by heating of the composition in liquid phase to obtain passage into vapor phase.

14. Method in accordance with claim 10 characterized in that the composition is dispersed in the environment by fine nebulization where the drops are sufficiently small to cause evaporation of the composition without abatement of the liquid phase.

15. Method in accordance with claim 10 characterized in that the composition is dispersed in the environment by micronizing or nebulization.

16. Method in accordance with claim 10 characterized in that the environment is held at a temperature higher than 0° C. and preferably in the range 10° C. to 75° C.

17. Method in accordance with claim 10 characterized in that the infested product is kept in the environment after dispersion of the composition for a period from 15 minutes to 96 hours.

18. Method in accordance with claim 10 characterized in that it calls for circulation movements inside the environment to make distribution of the concentration of the composition in the environment virtually homogeneous.

19. Method in accordance with claim 10 characterized in that after exposure in the environment in which the composition is dispersed the product is subjected to ventilation to remove the composition therefrom.

20. Method in accordance with claim 10 characterized in that at the end of treatment the air contained in the environment is subjected to a process of recovery of the dispersed composition in particular by condensation.
